(19) United States
(12) Patent Application Publication
(10) Pub. No.: US 2021/0241182 A1
(43) Pub. Date: Aug. 5, 2021

(54) METHOD AND SYSTEM FOR BUILDING A MACHINE LEARNING MODEL

(71) Applicant: Capital One Services, LLC, McLean, VA (US)

(72) Inventors: Abhishek SHRIVASTAVA, McKinney, TX (US); Boryana MANZ, Plano, TX (US); James FIEDLER, Austin, TX (US); Robert Cezeaux, San Francisco, CA (US)

(73) Assignee: Capital One Services, LLC, McLean, VA (US)

(21) Appl. No.: 16/782,144

(22) Filed: Feb. 5, 2020

(51) Int. Cl. G06N 20/20; G06K 9/62; G06F 9/54

(52) U.S. Cl. CPC G06N 20/20; G06F 9/542; G06K 9/623; G06K 9/6262

(57) ABSTRACT

A system and a process for building, monitoring, and rebuilding machine learning models includes building a plurality of machine learning models from a design specification, deploy the plurality of machine learning models for operation, and designating a champion and at least one challenger from the plurality of machine learning models built. The system and the process evaluate the plurality of machine learning models and provide results of the evaluation.

### TECHNICAL FIELD

The disclosed embodiments generally relate to building, monitoring, evaluating, and rebuilding of machine learning models.

### BACKGROUND

Modeling, particular modeling using big data, plays a large role in business operation. In many instances, business decisions are made based on predictions generated by various models. Model building, however, can be a time and resource intensive effort, especially if big data is involved. Model building can be quite complex, and thus manual building of models is limited by the strategies programmers can come up with for a complex model.

Model building by using a computer system left to itself may alleviate such problems, as this method uses automated computer algorithms to develop various models by using a large amount of available data to “learn.” These models are called machine learning models. Even so, there is generally a problem faced by programmers that each machine learning model must be built, tested, and deployed individually. It is often the case that, once a machine learning model is built, it is left running without any update because the resources needed to update the machine learning model are unavailable. This results in business units operating with outdated predictions, which may prevent business units from achieving optimal results.

### SUMMARY

Consistent with the present disclosure, there is provided a method for automatically building of a plurality of machine learning models using a build system, comprising: providing a design specification for the plurality of machine learning models to the build system, the design specification designating at least one of a machine learning model type, one or more sources of build data, one or more sources of scoring data and score data, and a deployment cycle; automatically retrieving build data from the one or more sources of build data, the build data comprising training data and validation data; automatically formatting the training data and validation data for storage in a repository; automatically constructing each of the plurality of machine learning models based on the respective machine learning model type, training data, and validation data; designating, from the plurality of machine learning models constructed, one champion and at least one challenger; automatically deploying the plurality of machine learning models including the champion and the least one challenger; to generate prediction data over the deployment cycle; automatically retrieving scoring data from the one or more sources of scoring data, and storing the scoring data the repository; automatically generating prediction data over the deployment cycle based on the scoring data; automatically retrieving score data from the one or more sources of score data, and storing the score data in the repository; automatically evaluating performances of the plurality of machine learning model by comparing the prediction data generated by each of the plurality of machine learning models with the scoring data, and storing the results of the evaluation in the repository; and generating a user interface to display the results of the evaluation stored in the repository.

Also consistent with the present disclosure, there is provided a build system for automatically building and monitoring a plurality of machine learning models, comprising: providing a design specification for the plurality of machine learning models to the build system, the design specification designating at least one of a machine learning model type, one or more sources of build data, one or more sources of scoring data and score data, and a deployment cycle; automatically retrieving build data from the one or more sources of build data, the build data comprising training data and validation data; automatically formatting the training data and validation data for storage in a repository; automatically constructing each of the plurality of machine learning models based on the respective machine learning model type, training data, and validation data; designating, from the plurality of machine learning models constructed, one champion and at least one challenger; automatically deploying the plurality of machine learning models including the champion and the least one challenger; to generate prediction data over the deployment cycle; automatically retrieving scoring data from the one or more sources of scoring data, and storing the scoring data the repository; automatically generating prediction data over the deployment cycle based on the scoring data; automatically retrieving score data from the one or more sources of score data, and storing the score data in the repository; automatically evaluating performances of the plurality of machine learning model by comparing the prediction data generated by each of the plurality of machine learning models with the score data, and storing the results of the evaluation in the repository; and generating a user interface to display the results of the evaluation stored in the repository.

The foregoing general description and the following detailed description are exemplary and explanatory only and are not restrictive of the claims.

### BRIEF DESCRIPTION OF THE DRAWINGS

The accompanying drawings are not necessarily to scale or exhaustive. Instead, emphasis is generally placed upon illustrating the principles of the embodiments described herein. The drawings, which are incorporated in and constitute a part of this specification, illustrate several embodiments consistent with the disclosure and, together with the detailed description, serve to explain the principles of the disclosure. In the drawings:

FIG. 1 is a diagram of an illustrative system for monitoring and rebuilding of machine learning models, consistent with disclosed embodiments.

FIG. 2 is a diagram of a computer system, consistent with disclosed embodiments.

FIG. 3 is a flowchart of an illustrative process for monitoring and rebuilding machine learning models, consistent with disclosed embodiments.

FIG. 4 is a high-level flowchart showing a building process of machine learning models consistent with disclosed embodiments.

FIG. 5 is a flowchart of an illustrative process of building machine learning models, consistent with one embodiment of the disclosure.

FIG. 6 is a flowchart of an illustrative process of building machine learning models, consistent with an alternative embodiment of the disclosure.

FIG. 7 is a diagram of operation of machine learning models during deployment, consistent with disclosed embodiments.

FIG. 8 is a flowchart an illustrative process of rebuilding machine learning models after deployment ends, consistent with disclosed embodiments.

### DETAILED DESCRIPTION

References will now be made in detail to exemplary embodiments, discussed with references to the accompanying drawings. In some instances, the same reference numbers will be used throughout the drawings and the following description refers to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. Thus, the materials, methods, and examples are illustrative only and are not intended to be necessarily limiting.

The disclosed embodiments describe a system and a process for building, monitoring, and rebuilding machine learning models without the need for intervening human effort. The disclosed embodiments further describe a system and a process that may take into account new data, not available initially when the machine learning models are built, to rebuild the machine learning models. The disclosed embodiments further describe a system and a process that may build a plurality of machine learning models from a single design specification, deploy the plurality of machine learning models for operation, and designate a champion and at least one challenger from the plurality of machine learning models built. The disclosed embodiments further describe a system and a process that retrieve scoring data and score data from various sources and store score data in a repository for ease of access. The disclosed embodiments further disclose a system and process that evaluates the plurality of machine learning models and provide results of the evaluation in forms of performance metrics in a graphic interface to an operator.

Machine learning models are useful by allowing computer systems to develop and optimize models without human intervention, thereby potentially reducing the time and resource cost of building and deploying models for users. However, building machine learning models can itself be a time and resource intensive process. During a build process, a data scientist may need to 1) write computer programs to retrieve data needed to train and validate a machine learning model, and 2) determine a machine learning model type most suitable for his/her needs. Moreover, once the machine learning model has been built and deployed, the data scientist is often not available to monitor the operations of the machine learning model, or to evaluate machine learning model performance with respect to a design target. This prevents the machine learning model from being kept up to date with new data that are generated. By using the system and the method disclosed herein, a plurality of machine learning models may be built based on a standardized design to leverage software modules and code libraries, be monitored during the operation while deployed, be evaluated at the end of the deployment, and be automatically rebuilt with new data.

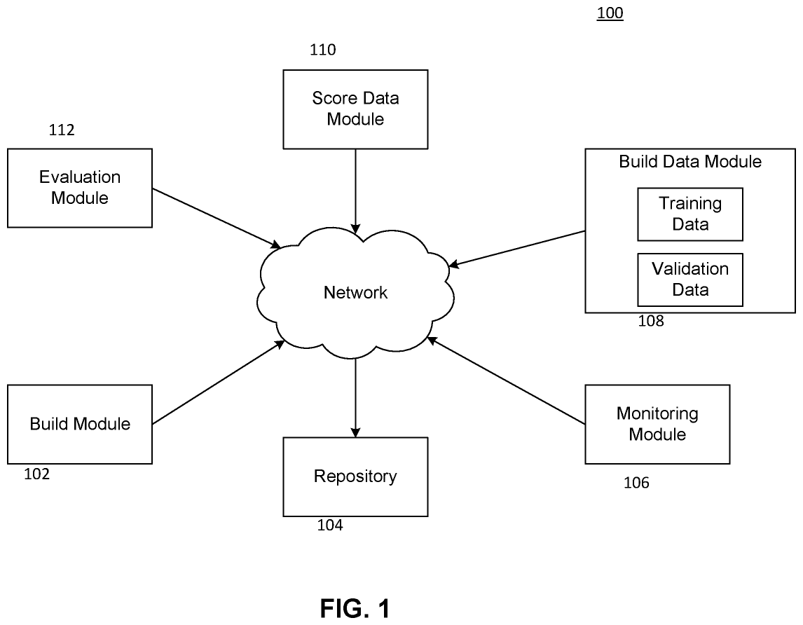

FIG. 1 illustrates an embodiment of a computer system 100 for carrying out the system and methods disclosed herein. Components and arrangements shown in FIG. 1 are not intended to limit the disclosed embodiments, as the components used to implement the disclosed features may vary. The computer system 100 includes the following modules: a build module 102, a repository 104, a monitoring module 106, a build data module 108, a score data module 110, and an evaluation module 112. While only a single one of each module is depicted in FIG. 1, the computer system 100 may include one or more of each of the shown components. Other components known to one of ordinary skill in the art may be included in the computer system 100 to gather, process, transmit, receive, and provide information used in conjunction with the disclosed embodiments.

The build module 102 may comprise a memory, a processor, and/or other specialized hardware that are configured to execute one or more methods of the disclosed embodiments. The build module 102 may be a desktop computer, laptop computer, tablet computer, smartphone, or any other suitable device with computing capability. Alternatively, the build module 102 may be a software module or application stored in the computer system 100. The build module 102 may have an application installed thereon, which may receive, process, store, and/or provide information. The application may include and/or execute one or more applications that request and/or receive information from one or more databases. The build module 102 may also transmit data, including one or more applications, to and receive data from, via a network 114.

The repository 104 may be a database capable of storing data. In some embodiments, the repository may be a memory storage component of the computer system 100. In other embodiments, the repository 104 may be a software module configured to capture, organize, store, and retrieve data associated with a particular application. For example, repository 104 may be a storage of all data that are associated with the computer system 100. In some embodiments, the repository 104 may also be configured to generate a visual display of data stored therein for output on a display screen.

The monitoring module 106 may comprise a memory, a processor, and/or other specialized hardware that are configured to execute one or more methods of the disclosed embodiments. The monitoring module 106 may be a desktop computer, laptop computer, tablet computer, smartphone, or any other suitable device with computing capability. The monitoring module 106 monitors the above mentioned plurality of machine learning models. The plurality of machine learning models generate prediction data for use by business units. The monitoring module 106 transmits prediction data via the network 114 to the repository 104 for storage. The plurality of machine learning models may include one champion and at least one challenger. The champion is one of the plurality of machine learning models designated to generate prediction data for business use, and the at least one challenger represents the plurality of machine learning models that generate prediction data for evaluation but may not necessarily be for business use.

The build data module 108 may be one or more databases capable of storing data. In other embodiment, the build data module 108 may be a software module configured to capture, organize, store, and retrieve data associated with building the plurality of machine learning models. The build data module 108 may retrieve and store both training and validation data, which are used in “training” the plurality of machine learning models. In some embodiments, the build data are historical data, and these data are provided via the network 114 to the build module 102 by the build data module 108. In some embodiments, once the build data module 108 retrieves the build data, the build data are transmitted to the repository 104 for storage.

The score data module 110 may be a database capable of storing the above mentioned score and scoring data. In some embodiments, the score data module 110 may be a memory storage component of the computer system 100. In other embodiment, the score data module 110 may be a software module configured to capture, organize, store, and retrieve data associated with performance of machine learning models. For example, the scoring data may be data gathered during the course of business operation. Assumed herein, the scoring data are inputs into the plurality of machine learning models, used to produce the predication data. The scoring data may be, for example, a number of residents within a geographical area used to predict how many new account openings may result from an advertising campaign. The score data are the actual real-life data corresponding to the prediction data. For example, the score data may be the actual number of account openings at the end of the advertising campaign. The disclosure is not limited to the examples of scoring data given herein, and an ordinary skilled person will now appreciate that many other types of business data may be gathered and stored as scoring data during the normal course of business operation. In some embodiments, the score data module 110 retrieves the scoring data, and the score data, transmits both to the monitoring module 106, and stores the score data in the repository 104.

The evaluation module 112 may comprise a memory, a processor, and/or other specialized hardware that are configured to execute one or more methods of the disclosed embodiments. The evaluation module 112 may be a desktop computer, laptop computer, tablet computer, smartphone, or any other suitable device with computing capability. Alternatively, the evaluation module 112 may be a software module or application stored in the computer system 100. For example, the evaluation module 112 may retrieve via the network 114, the score data and the prediction data from the repository 104 and perform analysis to evaluate the performance of the plurality of machine models. The evaluation module 112 may store the results of the analysis in the repository 104. Alternatively, the evaluation module 112 may receive score data and prediction data directly and store the results of the evaluation in the repository 104.

The computer system 100 may be configured to exchange data between its modules via the network 114. For example, the network 114 may be the Internet, a private data network, a virtual private network (VPN) using a public network, and/or other suitable connections that enable the various modules of FIG. 1 to send and acquire information. The network 110 may also include a public switched telephone network (“PSTN”) and/or a wireless network such as a cellular network, Wi-Fi network, and/or another known wireless network (e.g., WiMAX) capable of bidirectional data transmission. The network 114 may also be a wide area network (i.e., a WAN). The network 114 may also include one or more local networks (not pictured). A local network may be used to connect the modules of the computer system 100 of FIG. 1 to the network 114. A local network may comprise any type of computer networking arrangement used to exchange data in a localized area, such as Wi-Fi based on IEEE 804.11 standards, Bluetooth™, Ethernet, and other suitable network protocols that enable modules of the computer system 100 to interact with one another and to connect to the network 114 for interacting with components of FIG. 1.

The computer system 100 may include computing resources and software instructions for retrieving data, storing data and optimizing parameters of a machine learning model based on data. The computing devices may include one or more memory units for storing data and software instructions. The data may be stored in a database that may include cloud-based databases (e.g., Amazon Web Services S3 buckets) or on-premises databases. Databases may include, for example, Oracle™ databases, Sybase™ databases, or other relational databases or non-relational databases, such as Hadoop™ sequence files, HBase™, or Cassandra™ Database(s) may include computing components (e.g., database management system, database server, etc.) configured to receive and process requests for data stored in memory devices of the database(s) and to provide data from the database(s). The memory unit may also store software instructions that may perform computing functions and operations when executed by one or more processors, such as one or more operations related to data manipulation and analysis. The disclosed embodiments are not limited to software instructions being separate programs run on isolated computer processors configured to perform dedicated tasks. In some embodiments, software instructions may include many different programs. In some embodiments, one or more computers may include multiple processors operating in parallel. A processor may be a central processing unit (CPU) or a special-purpose computing device, such as graphical processing unit (GPU), a field-programmable gate array (FPGA) or application-specific integrated circuits.

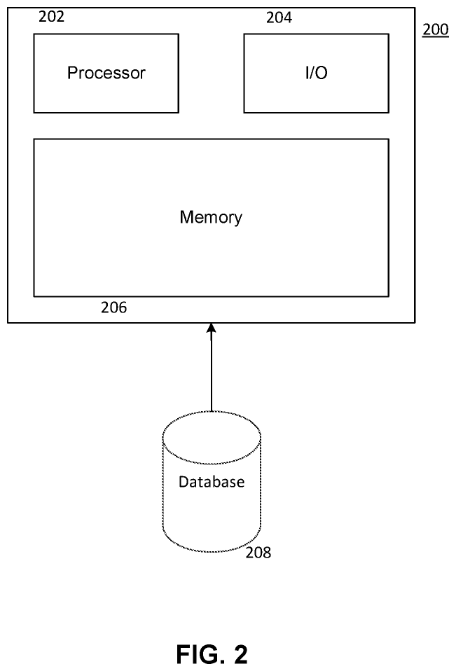

FIG. 2 is a diagram of a computer system 200, comprising one or more processor(s) 202, I/O device 204, memory 206, and connected to database 208. One or more modules of the computer system 100 may be software modules that are stored in memory 206 or database 208, which when executed, cause processor 202 to perform steps consistent with the disclosure. A skilled person will appreciate that either memory 206 or database 208 may serve as storage location for sources of any data that may require retrieval, and/or destination to store any data created.

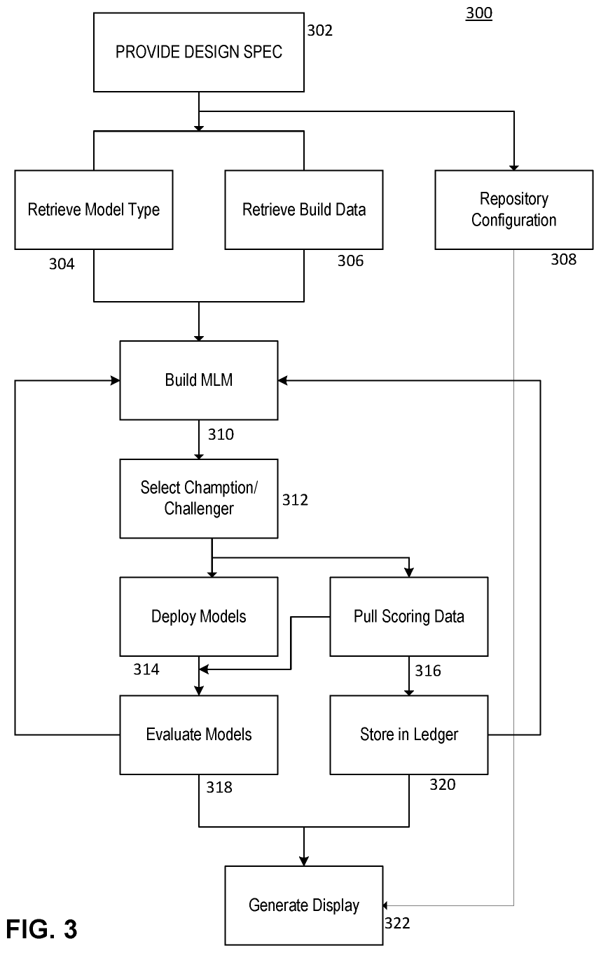

FIG. 3 is a flowchart of an illustrative process for monitoring and rebuilding machine learning models, consistent with disclosed embodiments.

Process 300 begins at step 302, at which a user provides a design specification to the build module 102. In some embodiments, the design specification is contained within a design document. The design document may be a standardize YAML formatted file. The design specification includes necessary “ingredients” to build a plurality of machine learning models. For example, the design specification may include at least one of a machine learning model type, one or more sources of build data, one or more tunable model parameters, and a number of machine learning models to be built. For example, the design specification may specify that n number of machine learning models are to be built, and that each of the machine learning models corresponds to a particular machine learning model type. In another example, the design specification specifies that each of the machine learning models have corresponding tunable model parameters to be optimized. Furthermore, the design specification may identify the build data to be used, and the storage location of the build data. The machine learning model types and tunable model parameters will be described in further detail below.

In other embodiments, the design specification may further include computer scripts for carrying out the build process and the monitoring process. For example, the design specification may include computer programs or scripts for retrieving the build data. In some embodiments, the build data may be stored in various locations in various formats. The design specification may comprise computer scripts for retrieving and formatting a particular set of build data for the build process of a particular machine learning model. Furthermore, the scoring data and the score data may also be located in various locations in various formats, and computer programs or scripts may be needed to retrieve and format the scoring and the score data. Alternatively, such computer scripts may be any computer codes or instructions that cause one or more processors to execute operations.

In some other embodiments, the design specification may include reference libraries from which software modules and codes may be retrieved. These reference libraries may be stored in GitHub, or other similar platforms. For example, a variety of machine learning model types may be stored in reference libraries, and the build module 102 may obtain one or more machine learning model types from one or more of these reference libraries. Similarly, a variety of optimization algorithms may be stored in reference libraries, and the build module 102 may obtain one or more optimization algorithms from one or more of these reference libraries. In some other examples, computer scripts for retrieving the build data, the scoring data, or the score data may be stored in reference libraries, and the monitoring module 106 and the build data module 108 may obtain one or more of the computer scripts needed from one or more of these libraries.

The exemplary embodiment discloses the design specification contained within a YAML formatted file. Alternatively, the design specification may be provided in programming languages such as Python, Java, PHP, C# or other similar computer programming languages. Moreover, the design specification may include other information necessary to build and deploy the plurality of machine learning models as a user may see fit.

In some other embodiments, the design specification may also include a deployment cycle. The deployment cycle defines a time period of a monitoring and rebuilding process. For example, a deployment cycle may define a period of three months (“quarterly”) for monitoring and updating of the plurality of machine learning models. In this example, the plurality of machine learning models are designed to operate for a period of 3 month before a rebuilding process updates the plurality of machine learning models. In some embodiments, the deployment cycle may further define a plurality of smaller increments of time for monitoring the plurality of machine learning models. For example, in addition to a deployment cycle of 3 month, the monitoring module 106 may check on the performance of one of the plurality of machine learning models to verify that model is performing within acceptable parameters. Alternatively, the above-described example is a non-limiting example, and that the deployment cycle may be defined as any time period that is suitable for business need and practicable in terms of implementation.

In step 304, the build module 102 retrieves one or more machine learning model types. The machine learning model type may be one of supervised learning, unsupervised learning, reinforcement learning, or deep learning. The machine learning model type may also be a mathematical formula or model stored in the reference libraries. The reference libraries may contain computer codes or scripts for building any of the one or more of machine learning models. Reference libraries may be stored in GitHub, or other similar platforms. A person having ordinary skill in the art will now appreciate that the above-mentioned model types are only examples, and the machine learning models types are not limited to these examples.

In step 306, the build data module 108 retrieves the build data from the one or more sources of build data designated by the design specification. The build data includes at least one of training data and validation data. The build data may be historical data and may be stored in various different database locations among different one of the business units. Once retrieved, the build data may be stored in the repository 104, so that during subsequent building and rebuilding of machine learning models, the build data are located in a known central location. This may allow the build data module 108 to retrieve data without need for specialized computer scripts.

In step 308, the repository 104 is configured based on the design specification. The repository 104 may be the storage of all retrieved and generated data in process 300.

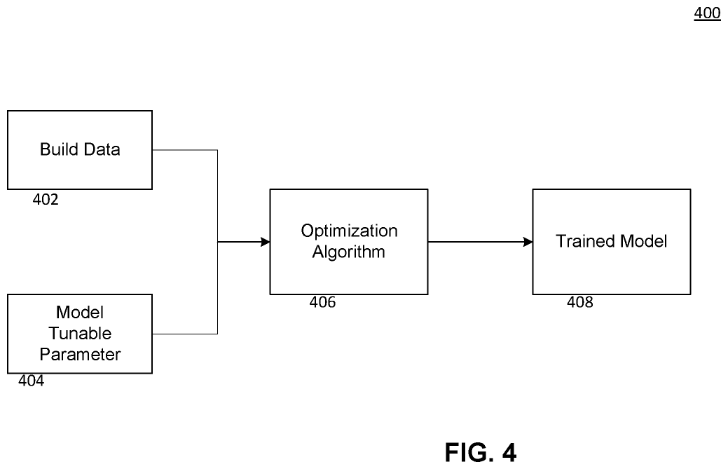

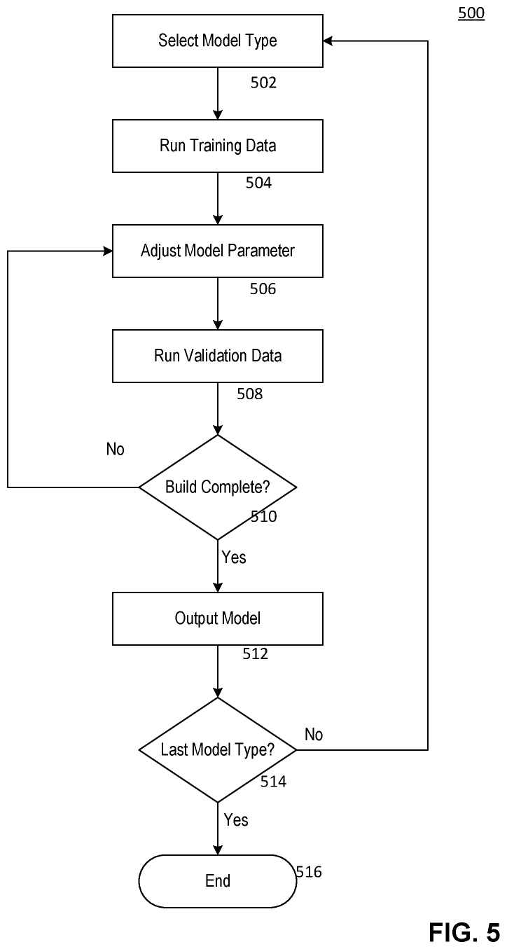

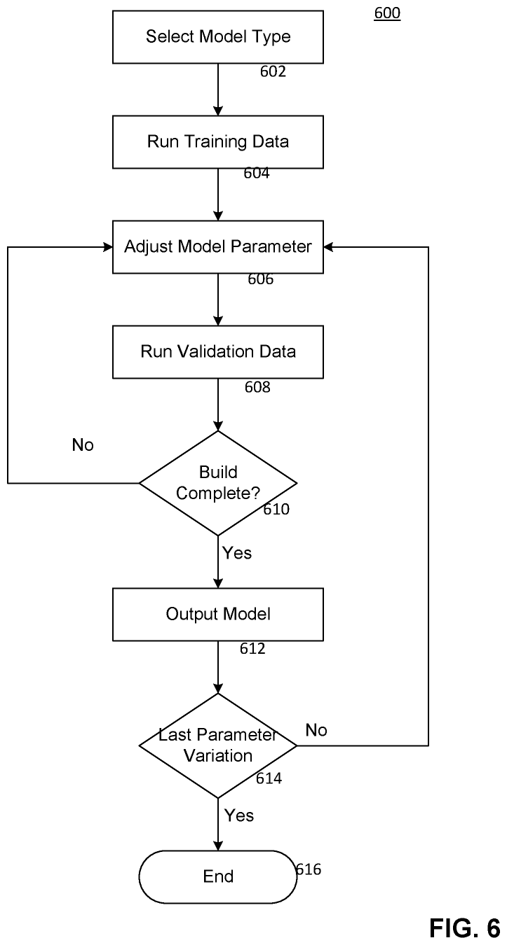

In step 310, the build module 102 builds the plurality of machine learning models. In this build process, the build module 102 “trains” a selected machine learning model type retrieved using the build data comprising the training data and the validation data. In step 310, multiple machine learning model types may be trained, or alternatively, a single machine learning model type may be trained using multiple optimization algorithms. Step 310 is described in more detail below with reference to FIG. 4, FIG. 5 and FIG. 6

In step 312, the build module 102 selects, from among the plurality of machine learning models built in step 310, a champion and at least one challenger. For example, if three machine learning models are built, one of these machine learning models will be designated as the champion, while the other two will be designated as challenger(s). The selection of the champion may be determined in the design specification. Alternatively, the champion may be selected by the business unit. In another alternative, during a rebuilding process, the champion may be selected automatically by the build module 102 based on a performance analysis from a previous deployment.

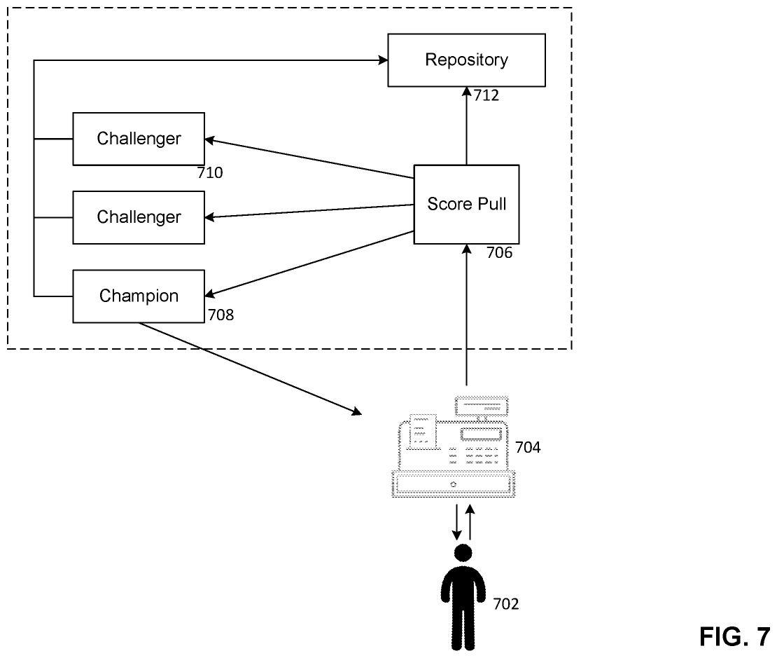

In step 314, the monitoring module 106 receives the champion and the challenger(s). In some embodiments, the monitoring module 106 deploys the champion and challenger(s) to generate prediction data. This deployment is based on the deployment cycle specified by the design specification. During the deployment cycle, the champion and the challenger(s) generate prediction data for use by the business unit. Alternatively, only the champion generates prediction data for business use, while at least one challenger generates prediction data only for monitoring purpose. The monitoring module 106 may store all generated prediction data in the repository 104. The operation of the champion and the challenger during the deployment will be described in more detail below with reference to FIG. 7.

In step 316, the score data module 110 may retrieve the scoring data and the score data. The scoring data are collected during a period of the deployment cycle and provided to the plurality of machine learning models for generating prediction data. For example, the scoring data may be collected by the business unit from various sources for the champion and the challenger(s) to generate the prediction data on deployment. The generation of the scoring data is described in more detail later in sections with reference to FIG. 7. The score data module 110 also retrieves the score data as they become available.

In step 318, the deployment of the champion and the challenger(s) ends at the end of the deployment cycle. The evaluation module 112 receives prediction data for each of the plurality of the machine learning models and the score data for generating evaluations for each of the plurality of machine learning models (the champion and the challenger(s)). The evaluations may be based on comparing the prediction data of one of the plurality of machine learning models to the score data corresponding to their respective input. The evaluations may calculate residual values between the prediction data and score data. The evaluation may also prompt for a redesignation of a champion and at least one challenger for subsequent rebuilding and deployment. Alternatively, other similar method of comparison may be used to evaluate the plurality of machine learning models using the score data. The evaluation will be described in more detail below with reference to FIG. 7.

In step 320, the score data is stored in the repository 104.

At the end of step 320, results of the evaluation may be displayed to users. In some embodiments, results of evaluation are transmitted to the build module 102 to help with the rebuilding process. In further embodiments, the score data stored in repository 104 may be transmitted to the build data module 108 to update the training data and the validation data. The build module 102 repeats step 310 to re-train the plurality of machine learning models based the results of evaluation and the updated training and the validation data. In some embodiments, steps 310-322 may be repeated.

Process 300 is only a non-limiting exemplary embodiment. In an alternative embodiment, for example, the evaluation of the plurality of machine learning model may occur simultaneously with the deployment of the champion and the challenger(s). The monitoring module 106 and the score data module 110 may send real-time prediction data and score data to the evaluation module 112, so that evaluations take place in real time. In alternative embodiments, the monitoring module 106 and the score data module 110 may send prediction data and score data to the evaluation module 112 in intervals defined by the deployment cycle, so that the evaluations take place in the defined intervals. In another alternative embodiment, during the deployment cycle, a new champion may be designated from among the at least one challenger, and the replaced champion becomes one of challenger(s).

In another alternative embodiment, the plurality of machine learning models may be built and deployed in a staggered deployment cycle. In a non-limiting example of staggered deployment, the design specification may specify that three machine learning models are to be built and deployed. The build module 102 may build and deploy a machine learning model A in steps 310 and 314. After a specified time, the build module 102 then builds and deploys a machine learning model B. After another specified time, the build module 102 builds and deploys a machine learning model C. A skilled person will now appreciate that the deployment cycle for the machine learning models A, B, and C may be different so that the machine learning models A, B, and C end deployment simultaneously. Alternatively, the deployment cycle may be the same length and earlier machine learning models end deployment before later machine learning models. A skilled person will now also appreciate that the score data module 110 may update the build data module 108 based on the scoring data and the score data from the earlier machine learning models, so that the build data module 108 can retrieve updated build data for the later machine learning models. For example, the score data module 110 may retrieve scoring data and score data for machine learning model A and update the build data in step 312. When the build module 102 builds the machine learning model B, build data used for the machine learning model B will be different from that used in building machine learning model A.

FIG. 4 is a high-level flowchart showing a build process of a machine learning models consistent with disclosed embodiments, related to step 310 in process 300. In process 400, the build process includes build data 402, tunable model parameters 404, and optimization algorithms 406 to output a machine learning model 408.

The build data 402 includes the training data and the validation data. The training data is a data set used to train the machine learning model 408. For example, it may be a set of output values corresponding to a set of input values. The tunable model parameters 402 may be parameters specific to a machine learning model type that determines the characteristics of the specific machine learning model. In a non-limiting example, if the particular machine learning model type is an equation for a straight line, the particular machine learning model is y=ax+b, and the tunable model parameters 404 are a and b. The corresponding training data may be a first list of values of ys and corresponding xs. The validation data would be a second list of values of ys and corresponding xs, different from the first list of values. The build module 102 would “validate” a particular set of tunable model parameters 404 (as and bs) by comparing outputs of a particular machine learning model having a particular set of tunable model parameters 404 with the validation data.

The optimization algorithms 406 represents methods through which the tunable model parameters 404 are determined based on the training data. The optimization algorithms 406 are specified in the design specification. The build module 102 uses the optimization algorithms 406 to train a machine learning model. The optimization algorithms 406 may be included in the design specification. Alternatively, the optimization algorithms 406 may be stored in reference libraries that are designated by the design specification. In the above illustrative example of the machine learning model y=ax+b, exemplary optimization algorithms 406 search for values of a and b such that the difference between the value of y and ax+b is minimized. Alternatively, another example of optimization algorithms 406 search values of aₛ and bₛ such that the difference between the value of y and ax+b converges to a target value, wherein the target value may be a predetermined value included in the design specification.

The above-described illustrative examples of optimization algorithms 406 may be a least squared method for a linear regression machine learning model type. A skill person will now appreciate that these are merely non-limiting examples of machine learning model types and optimization algorithms. For example, alternative embodiments of machine learning model types may include support-vector machine, logistic regression, naive Bayes method, decisions trees, k-NN, similarity learning, or any similar supervised machine models.

In some alternative embodiments, the machine learning models may include neural networks, recurrent neural networks, generative adversarial networks, and models based on ensemble methods, such as random forests. The machine-learning model types may have parameters selected for optimizing the performance of the machine-learning models. For example, parameters specific to the particular type of model (e.g., number of features and number of layers in a generative adversarial network or recurrent neural network) may be optimized to improve model performance.

In some other alternative embodiments, the machine learning model types may include reinforcement learning models, in which the training data and the validation data need not be in the form of input/output pairs, or that sub-optimal actions need not be explicitly corrected. The accompanying optimization algorithms 406 may instead focus on finding a balance between exploration of unknown and exploitation of what is known. A person having ordinary skill in the art will now appreciate that reinforcement learning model types may include Monte Carlo, Q-learning, SARSA or other similar method.

Process 400 may repeat for each of the plurality of machine learning models that the build module 102 builds. Each of the plurality of machine learning models may have different machine learning model types or tunable model parameters 404 as specified by the design specification.

FIG. 5 is a flowchart of an illustrative process 500 of building machine learning models, consistent with one embodiment of the disclosure, representing step 310 of process 300 of FIG. 3. FIG. 5 shows one exemplary implementation of the high-level process illustrative in FIG. 4. For example, process 500 shows a non-limiting example of a build process of a supervised machine learning model, which may be one of the plurality of machine learning model types. It will be now appreciated that process 500 may be performed by the computer system 100.

In step 502, the build module 102 selects a machine learning model type for training. The selection in step 502 is based on the design specification provided in step 302, from among the machine learning model types obtained in step 304. In the following non-limiting example, the machine learning model type selected for training is a linear regression model with a least square optimization method. The build module 102 receives the machine learning model type selected and the associated optimization method from one or more reference libraries specified by the design specification. The reference libraries may be stored on GitHub or similar platforms.

In step 504, the build module 102 trains the selected machine learning model type using training data previously obtained in step 306, the training data being included in the build data. In the non-limiting example, the training data is a data set containing y values with corresponding x values. The build module 102 uses the training data to train the machine learning model type into a machine learning model. Alternatively, the training data may be different types of data. For example, the training data may be pictures, audio files, video clip, text files or any data type formatted to be suitable for training a machine learning model.

In step 506, one or more tunable model parameters 404 of the selected machine learning model type is determined by “training.” In the non-limiting example, if the machine learning model type is a linear regression model with the equation y=ax+b, the build module 102 may use, for example, the least squared optimization method, to obtain values of a and b, such that the obtained values of a and b cause the machine learning model type y=ax+b to “fit” the training data the “best.” In the non-limiting example using the least squared method, the “best” represents when the residuals between the training data and output data of y=ax+b is minimized. Alternatively, embodiments using different machine learning model types and different optimization algorithms, the determination of “best” would be different.

In step 508, once the build module 102 determines the tunable model parameters 404 of the selected machine model type, the machine learning model is trained. Using the above non-limiting example, once the “best” values of a and b are determined, these best values may be defined as, for example, a₀ and b₀. The trained machine model would, for example, become y=a₀x+b₀. Step 508 applies the validation data obtained in step 306 to “validate” the trained machine learning model. The validation data has similar characteristics to the training data so that, in theory, if the trained machine learning model had been optimized, it should generate prediction data that are within a target value of the validation data. In the non-limiting example, the validation data are a set of y values with corresponding x values. For example, during validation, for a given value of x in the validation data, the trained machine learning model should produce a prediction of a y value. The difference between the predicted y value and the corresponding y value in the validation data would preferably be within a target value, the target value being a predetermined value as specified in the design specification. Alternatively, the target value may be a predetermined value, a function, or any other techniques known in the art that may describe a convergence threshold.

In step 510, in the non-limiting example, if the trained machine learning model passes validation in step 508, the build module 102 determines that “Build Complete” is “Yes”, and the trained machine learning model becomes an output machine learning model in step 512, forming one of the plurality of machine models for deployment. If the trained machine learning model does not pass validation in step 508, the build module determines that “Build Complete” is “No,” and the trained machine learning model repeats step 506 such that its tunable model parameters 404 are adjusted.

In step 514, the build module 102 determines based on the design specification whether the build process is complete by determining whether another machine learning model type is to be trained to build another machine learning model. If another machine learning model type is required by the design specification, the build module 102 will repeat step 504. In the non-limiting example above, the system will select another machine learning model type, which may be different from the last machine learning model type trained, for example, a logistics regression model. The next machine learning model type is then built by performing steps 504-514, similar to the last machine learning model built.

If no more machine learning model types are required, the build module 102 will end the build process, and the computer system 100 proceeds to step 516.

Alternatively, the other machine learning model types may be implemented. For example, alternative supervised machine learning models type such as support-vector machine, logistic regression, naive Bayes method, decision trees, k-NN, similarity learning, or any similar supervised machine models. Such other machine learning model types may also be implemented in some neural networks, recurrent neural networks, generative adversarial networks, and models based on ensemble methods, such as random forests. Such other machine learning models type may further include reinforcement learning models, in which the training data and validation data need not be in the form of input/output pairs, or that sub-optimal actions need not be explicitly corrected. The corresponding optimization algorithms 406 may instead focus on finding a balance between exploration of unknown and exploitation of what is known. A person having ordinary skill in the art will now appreciate that reinforcement learning models may include Monte Carlo, Q-learning, SARSA or other similar methods.

FIG. 6 is a flowchart of an illustrative process 600 of building machine learning models, related to step 310, consistent with an alternative embodiment of the disclosure. In the alternative embodiment, the design specification may only specify one machine learning model type for the plurality of machine learning models. It may be known that a particular machine learning model type, for example, a linear regression model, is desired for a business purpose. In this non-limiting example, the design specification may specify that the plurality of machine learning models would all be linear regression models. However, it may still be desired that each of the plurality of the machine learning models has different parameters so that they may produce different prediction data from each other. The different prediction data may be valuable for evaluation purposes.

In step 602, the build module 102 selects a machine learning model type for training. The selection in step 602 is based on the design specification provided in step 302. As noted above, in this non-limiting example, the design specification specifies only one model type. The type of machine learning model selected for training may be a linear regression model. The build module 102 receives the type of machine learning model selected and the associated optimization method from one or more reference libraries specified by the design specification. The reference libraries may be stored on GitHub or similar platform.

In step 604, the build module 102 trains the selected machine learning model using training data previously obtained in step 306, the training data being included in the build data. In the non-limiting example, the training data is a data set containing values of y with corresponding values of x of the linear regression model y=ax+b. The build module uses the training data to train the machine learning model type to build a machine learning model. Alternatively, the training data may be different types of data. For example, training data may be pictures, audio files, video clip, text files, or any data type formatted to be suitable for training the machine learning model type selected based on the design specification.

In step 606, one or more tunable model parameters 404 of the selected machine learning model type are determined. In the non-limiting example described above, if the machine learning model type is a linear regression model with the equation y=ax+b, the build module may use, for example, the least square optimization method, to obtain values of a and b, such that the obtained values of a and b cause the machine learning model type y=ax+b to “fit” the training data the “best.” In the non-limiting example using the least square method, the “best” represents when the residuals between the training data and output data from y=ax+b are minimized. Alternatively, embodiments using different machine learning model types and different optimization algorithms, the determination of “best” may be different.

In step 608, once the build module 102 determines the tunable model parameters 404 of the selected machine model type, the machine learning model is trained. In the above mentioned non-limiting example, once the “best” values of a and b are determined, this best value may be defined as, for example, a₀ and b₀. The trained machine model would become y=a₀x+b₀. Step 608 applies the validation data obtained in step 306 to “validate” the trained machine learning model. The validation data has similar characteristics to the training data such that in theory, if the trained machine learning model had been optimized, it should generate prediction data that is within a target value of the validation data. In the non-limiting example, the validation data would be a set of y values with corresponding x values. For example, during validation, for a given value of x in the validation data, the trained machine learning model should produce a prediction of ay value. The difference between the predicted y value and the y value in the validation data would preferably be within the target value, the target value being a predetermined value as specified in the design specification. Alternatively, the target may be a predetermined value, a function, or any other technique known in the art that may describe a convergence threshold.

In step 610, in the non-limiting example, if the trained machine learning model passes validation in step 608, the build module 102 determines that “Build Complete” is “Yes”, and the trained machine learning model becomes an output machine learning model in step 612, forming one of the plurality of machine model for deployment. If the trained machine learning model does not pass validation in step 608, the build module 102 determines that “Build Complete” is “No,” and trained machine learning model repeats step 606 to adjust the tunable model parameters.

In step 614, the build module 102 determines based in the design specification whether the build process is complete by determining whether another machine learning model with different tunable model parameters 404 is to be trained to build another machine learning model. If another machine learning model is required by the design specification, the build module 102 will repeat step 606. In the non-limiting example above, the build module 102 selects an optimization algorithm 406 different from the algorithm used for the previous machine learning model trained. For example, if a least square method is used in the previous trained machine learning model, then a different optimization method, for example, maximum likelihood estimation method may be used to train the next machine learning model. In the non-limiting example, the next machine learning model may have different values of a and b, for example, a₁ and b₁, such that the next machine learning model is y=a₁x+b₁.

If no more machine learning models are required, the build module 102 will end the build process, and the computer system 100 proceeds to step 312.

Alternatively, the optimization algorithms are not limited to the examples described above, and that the machine learning model type is not limited to the above example. Furthermore, alternatively, the build module may not utilize different optimization algorithms 406 to train the next machine learning model. For example, the build module 102 may use the same optimization algorithm 406 but arrive at values for a₁ and b₁ that differ from a₀ and b₀.

FIG. 7 is a diagram of operation of the plurality machine learning models that have been built in step 310 during deployment, consistent with disclosed embodiments.

In an exemplary embodiment, the monitoring module 106 deploys the plurality of machine learning models in step 314. For example, during the deployment, a customer 702 may interact with a business unit 704 to generate score data, which is retrieved during a score pull operation 706 by the score data module 110. Also during the deployment, one of the plurality of machine learning models, a champion 708, may provide the business unit 704 with prediction data. The one or more challenger(s) 710 also generate prediction data, and all of the prediction data may be stored in a repository 712. In some embodiments, the scoring pull operation 706 also feeds the scoring data to the plurality of machine learning models directly, so that the score data and the respective prediction data can be compared in real time.

In a non-limiting example, the champion 708 may predict that an advertisement promotion targeted to a particular region results in a number of new accounts opened within a time period. The business unit 704 may use that prediction data to decide to launch an advertisement promotion targeted to the particular region. Within the time period, the business unit 704 will collect the number of new accounts opened. This data is obtained during the score pull operation 706 to be stored in the repository 712. In some embodiments, the challenger(s) 710 may also generate predictions of a number of new accounts opened within a time period during the promotional time period, and these data may also be stored in the repository 712 for comparison with the prediction of the champion. In some alternative embodiments, the prediction data generated by the challenger(s) 710 may also be provided to the business unit in a predetermined time interval as defined in the design specification so that comparison of prediction data by the plurality of machine learning models may be compared simultaneously.

In some embodiments, the monitoring module 106 may continuously monitor other aspects of the plurality of machine learning models. For example, the monitoring module 106 may monitor for partial or complete failure of the plurality of machine learning models, based on criteria predetermined by the design specification.

In some embodiments, the business unit may desire to redesignate among the plurality of machine learning models a new champion. For example, the business unit 704 may discover that one of the challenger(s) 710 produces more desirable prediction data.

Alternatively, the total number of challenger(s) 710 is only limited by the available computing resources of business unit 704. In conventional machine learning building process, the number of machine learning models that could be deployed is not only limited by the available computing resources, but also the available human labor in building the machine learning models. It is often the case that a business unit has sufficient computing resources to allow multiple machine learning models to simultaneously generate outputs but is unable to fully exploit its computing resources because it may not be practical to build multiple machine learning models because of insufficient number of data scientists. The present embodiment discloses improvements to overall computer system efficiency by greatly reducing the time and resources needed to build and evaluate machine learning models, therefore allows for utilization of computing resources that may otherwise be idle.

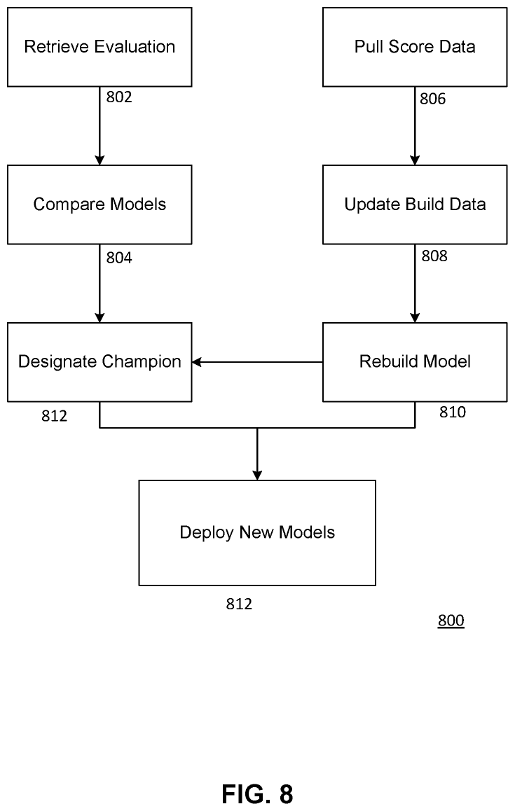

FIG. 8 is a flowchart an illustrative process 800 of rebuilding machine learning models after deployment ends, consistent with disclosed embodiments.

In step 802, the evaluation module 112 evaluates the plurality the machine learning models. The evaluation module 112 retrieves the prediction for each of the plurality the machine learning models and the score data corresponding to a relevant evaluation. The score data may be pulled in step 806 from the repository where it is stored. Alternatively, the score data may be retrieved while the scoring data is continuously fed to the plurality the machine learning models during the deployment cycle so that the evaluation was performed in predetermined intervals as the prediction data were generated by the plurality the machine learning models. Using the above mentioned non-limiting example, one of the plurality of machine learning models is y=a₀x+b₀. During the deployment cycle for a given set of scoring data x_{dep}, the model generates a corresponding prediction value of y_{pred}. Simultaneously during the deployment cycle, the score data are generated, for example, from customer interaction, that for the same given scoring data x_{dep}, the score data is y_{score}. Evaluation of one of the machine learning models may determine the difference between the y_{pred} and y_{score}.

Alternatively, various statistical methods may be employed to evaluate the difference between the predication data and the score data. For example, metrics such as residual, variance, and/or bias may be calculated from the difference between the prediction data and the score data. A skilled person will now appreciate other metrics may be generated with known statistical methods to evaluate the plurality the machine learning.

In step 804, the evaluation for each of the plurality of machine learning models may be compared. In some embodiments for example, the evaluation module 112 may receive the performance metrics of each of the machine learning models from the deployment cycle and perform a comparison between each model of the afore-mentioned metrics such as residual, variance, and/or bias for each of each of the machine learning models. The comparison, for example, can be used to rank the plurality of machine learning models from a best performing model to a worst performing model. The best performing model, for example, may be a machine learning model from among the plurality of machine learning models that has the lowest residuals. A skill person will now appreciate that a different performance ranking may be formed based on a different metric, such as variance, bias, or other similar metric suitable to measure performances of machine learning models.

In some embodiments, in step 804, the evaluation module 112 may compare one of the plurality of the machine learning models with its previous iterations. For example, in some embodiments, the evaluation module 112 retrieves from the repository 104, historical performance metrics corresponding the one of the plurality of the machine learning models from previous deployment cycles. It may be the case that once a specific machine learning model is built, it may be deployed for multiple cycles. At the end of each of the deployment cycles, the performance metrics for the specific machine learning model for that cycle are saved in the repository 104. In this manner, the performance metrics of the specific machine learning model may be tracked through every deployment for its subsequent rebuild versions.

In some embodiments, in step 804, these performance metrics may be formatted for display on a user interface to a user. The user may be a member of the business unit 704, or alternatively, the user may be a data scientist responsible for designing and maintaining the plurality of machine learning models. In a non-limiting example, the user interface may display in graphic charts, one or more of the performance metrics so that the user can view the residual, variance, bias, and/or similar performance metrics of a specific machine learning model simultaneously. In another example, the performance metrics for all of the plurality of machine learning models may be viewed all at once by overlaying the performance metrics for all of the plurality of the machine learning model. Alternatively, the performance metric may be displayed in text form, or in graphical charts or plots, and the information presented on the user interface may be any combination of the performance metrics of the plurality of machine learning models or the different versions of the same machine learning model.

In step 808, the evaluation module 112 updates the build data module 108. Referring again to in step 306, in some embodiments the build data module 108 may retrieve the build data from different sources and provide the build data to the build module 102. Once the build data is retrieved, the build data module 108 stores the retrieved build data in the repository 104 so that the build data is easily locatable for future use. In each deployment cycle, the score data module 110 acquires scoring data and score data from business unit 704, the scoring data being different from the build data. In some embodiments, the build data are historical data, while the scoring data are data generated during the deployment cycle. Therefore, it is desirable that the build data are updated with scoring data and score data such that a machine learning model built using the updated build data is more “up-to-date” than one built using the original build data. The scoring data and the score data may be used to update either the training data, the validation data, or both, so long as the training data and the validation data are different from each other.

In step 810, the plurality of machine learning models are rebuilt. The rebuilding process is carried out by the build module 102 similar to the process illustrated in FIG. 4, FIG. 5, and FIG. 6. For example, in one embodiment, the build module 102 begins the rebuilding process in step 504 by selecting the same machine learning model type for training corresponding to the machine learning model type selected in the previous deployment. In step 504, the build module trains the same machine learning model using training data updated with the scoring data and the score data obtained in step 808. In step 506, tunable model parameters 404 of the same machine learning model are optimized as described previously. In step 508, the build module 102 validates the same machine learning model is using updated validation data obtained in step 808. If the rebuilt same machine learning model passes validation step 510, the rebuilding of one of the machine learning models is complete, and the build module 102 repeats these steps until all of the plurality of machine learning models are rebuilt using the updated build data.

Building of the plurality of machine learning models according to the build process 600 is similar. For example, in an alternative embodiment, the build module 102 begins the rebuilding process in step 602 by selecting the same machine learning model type for training corresponding to the machine learning model type selected in the previous deployment. In step 604, the build module 102 trains the same machine learning model using training data updated with the scoring data and the score data obtained in step 808. In step 606, tunable model parameters 404 of the same machine learning model are optimized as described previously. In step 608, the build module 102 validates the same machine learning model using updated validation data obtained in step 808. If the rebuilt same machine learning model passes validation step 610, the rebuilding of one of the machine learning model is complete, and the build module 102 repeats these steps until all of the plurality of machine learning models are rebuilt using the updated build data.

In step 812, the build module 102 may designate a champion and at least one challenger from the plurality of rebuilt machine learning models. For example, the build module 102 may designate the champion based on a comparison between each of the plurality of machine learning models in step 804. The build module 102 may automatically designate the champion based on one or more criteria defined in the design specification. For example, the build module 102 may automatically designate the as the champion the machine learning model having the least residual, variance or bias. Alternative, the build module 102 may consider all of the performance metrics, and designate the champion based on a combination of performance metrics. For example, the build module 102 may assign a grade to each of the performance metrics used for each of the machine learning models and designate the machine learning model with the highest or lowest grade.

In other embodiments, the build module 102 may receive input from the user to designate the champion. For example, the user may review the performance metrics displayed on the user interface and decide to designate one of the plurality of machine learning models as the champion.

Alternatively, the build module 102 may not designate the existing champion as the new champion. For example, the design specification may direct the build module 102 to maintain the existing champion after the plurality of machine learning models have been rebuilt.

In step 814, the plurality of rebuilt machine learning models are deployed, corresponding to step 314 in process 300.

While illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from a consideration of the specification and practice of the embodiments disclosed herein. It is intended that the specification and examples be considered as an example only, with a true scope and spirit of the disclosed embodiments being indicated by the following claims.

Descriptions of the disclosed embodiments are not exhaustive and are not limited to the precise forms or embodiments disclosed. Modifications and adaptations of the embodiments will be apparent from consideration of the specification and practice of the disclosed embodiments. For example, the described implementations include hardware, firmware, and software, but systems and techniques consistent with the present disclosure may be implemented as hardware alone. Additionally, the disclosed embodiments are not limited to the examples discussed herein.

Computer programs based on the written description and methods of this specification are within the skill of a software developer. The various programs or program modules may be created using a variety of programming techniques. For example, program sections or program modules may be designed in or by means of Java, C, C++, assembly language, or any such programming languages. One or more of such software sections or modules may be integrated into a computer system, non-transitory computer-readable media, or existing communications software.

In this description, the conjunction “and/or” may mean each of the listed items individual, a combination of the listed items, or both. Moreover, the “and/or” conjunction as used in this specification may include all combinations, sub-combinations, and permutations of listed items. For example, the phrase “A, B, and/or C” may mean each of A, B, and C individually, as well as A, B, and C together in addition to sub-groups A and B, A and C, and B and C. Unless specified otherwise, this example use of “and/or” may also intend to include all potential orders of items in each group and sub-group, such as B-C-A, B-A-C, C-A-B, C-B-A, and A-C-B, along with the subgroups C-B, B-A, and C-A.

Moreover, while illustrative embodiments have been described herein, the scope includes any and all embodiments having equivalent elements, modifications, omissions, combinations (e.g., aspects across various embodiments), adaptations, or alterations based on the present disclosure. The elements in the claims are to be interpreted broadly based on the language employed in the claims and not limited to examples described in the present specification or during the prosecution of the application, of which examples are to be construed as non-exclusive. Further, the steps of the disclosed methods may be modified in any manner, including by reordering steps or inserting or deleting steps. It is intended, therefore, that the specification and examples be considered as exemplary only, with the true scope and spirit being indicated by the following claims and their full scope of equivalents.

1. A non-transitory computer-readable medium storing computer program instructions that, when executed by one or more processors, effectuate operations comprising:
providing a design specification for a plurality of machine learning models to a build system, the design specification designating at least one of a machine learning model type to be built, one or more sources of build data, one or more sources of scoring data and score data, and a deployment cycle;
automatically, and without human intervention, retrieving build data from the one or more sources of build data, the build data comprising training data and validation data;
automatically, and without human intervention, constructing each of the plurality of machine learning models based on the respective machine learning model type, the training data, and the validation data to obtain a plurality of constructed machine learning models;
automatically, and without human intervention, designating, from the plurality of constructed machine learning models, a champion and at least one challenger;
automatically, and without human intervention, deploying the plurality of constructed machine learning models including the champion and the at least one challenger;
automatically, and without human intervention, retrieving scoring data from the one or more sources of scoring data;
automatically, and without human intervention, generating prediction data over the deployment cycle based on the scoring data;
automatically, and without human intervention, retrieving score data over the deployment cycle from the one or more sources of score data;
automatically, and without human intervention, computing one or more performance metrics based on the prediction data generated by each of the plurality of machine learning models and the score data to evaluate performances of the plurality of machine learning models;
in response to the deployment cycle ending, automatically, and without human intervention, updating the build data based on the scoring data and the score data to obtain updated build data, wherein the updated build data comprises updated training data and updated validation data;
automatically, and without human intervention, rebuilding each of the plurality of constructed machine learning models based on the updated training data and the updated validation data to obtain a plurality of rebuilt machine learning models; and
automatically, and without human intervention, designating a new champion and at least one new challenger from the plurality of rebuilt machine learning models based on the one or more performance metrics.

2. (canceled)

3. The non-transitory computer-readable medium of claim 1, wherein the operations further comprise:
automatically, and without human intervention, deploying the plurality of rebuilt machine learning models including the new champion and the at least one new challenger to generate updated prediction data over an additional deployment cycle.

4. The non-transitory computer-readable medium of claim 1, wherein the design specification is a YAML formatted file, and the design specification further includes one or more scripts for automatically retrieving and formatting the build data.

5. The non-transitory computer-readable medium of claim 1, wherein the machine learning model type to be built is stored in a reference library, and the design specification identifies the reference library.

6. The non-transitory computer-readable medium of claim 5, wherein the reference library is stored in a data repository, and the machine learning model type to be built is retrieved from the data repository.

7. The non-transitory computer-readable medium of claim 1, wherein the design specification further includes a target score and one or more model parameters for each of the plurality of machine learning models.

8. The non-transitory computer-readable medium of claim 7, wherein automatically, and without human intervention, constructing each of the plurality of machine learning models is further based on the target score and the one or more model parameters for each of the plurality of machine learning models.

9. The non-transitory computer-readable medium of claim 1, wherein the build data are historical data and the scoring data and the score data are current data retrieved during the deployment cycle.

10. The non-transitory computer-readable medium of claim 9, wherein the operations further comprise:
automatically, and without human intervention, designating the at least one challenger as the champion based on a user input.

11. A build system for automatically building a plurality of machine learning models, comprising:
a network controller;
at least one processor; and
a storage medium storing instructions that, when executed, configure the at least one processor to perform operations comprising:
obtaining a design specification for the plurality of machine learning models, the design specification designating at least one of a machine learning model type to be built, one or more sources of build data, one or more sources of scoring data and score data, and a deployment cycle;
automatically, and without human intervention, retrieving build data from the one or more sources of build data, the build data comprising training data and validation data;
automatically, and without human intervention, constructing each of the plurality of machine learning models based on the respective machine learning model type, the training data, and the validation data to obtain a plurality of constructed machine learning models;
automatically, and without human intervention, designating, from the plurality of constructed machine learning models, a champion and at least one challenger;
automatically, and without human intervention, deploying the plurality of constructed machine learning models including the champion and the at least one challenger;
automatically, and without human intervention, retrieving scoring data from the one or more sources of scoring data;
automatically, and without human intervention, generating prediction data over the deployment cycle based on the scoring data;
automatically, and without human intervention, retrieving score data over the deployment cycle from the one or more sources of score data;
automatically, and without human intervention, computing one or more performance metrics based on the prediction data generated by each of the plurality of machine learning models and the score data to evaluate performances of the plurality of machine learning models;
in response to the deployment cycle ending, automatically, and without human intervention, updating the build data based on the scoring data and the score data to obtain updated build data, wherein the updated build data comprises updated training data and updated validation data;
automatically, and without human intervention, rebuilding each of the plurality of constructed machine learning models based on the updated training data and the updated validation data to obtain a plurality of rebuilt machine learning models; and
automatically, and without human intervention, designating a new champion and at least one new challenger from the plurality of rebuilt machine learning models based on the one or more performance metrics.

12. (canceled)

13. The build system of claim 11, wherein the operations further comprise:
automatically, and without human intervention, deploying the plurality of rebuilt machine learning models including the new champion and the at least one new challenger to generate updated prediction data over an additional deployment cycle.

14. The build system of claim 11, wherein the design specification is a YAML formatted file, and the design specification further includes one or more scripts for automatically retrieving and formatting the build data.

15. The build system of claim 11, wherein the machine learning model type to be built is stored in a reference library, and the design specification identifies the reference library.

16. The build system of claim 15, wherein the reference library is stored in a data repository, and the machine learning model type is retrieved from the data repository.

17. The build system of claim 11, wherein the design specification further includes a target score and one or more model parameters for each of the plurality of machine learning models.

18. The build system of claim 17, wherein automatically, and without human intervention, constructing each of the plurality of machine learning models is further based on the target score and the one or more model parameters for each of the plurality of machine learning models.

19. The build system of claim 11, wherein the build data are historical data and the scoring data and the score data are current data retrieved during the deployment cycle.

20. The build system of claim 11, wherein during the deployment cycle, the prediction data generated by the champion is used for business operation.

21. The non-transitory computer-readable medium of claim 1, wherein the champion represents one of the plurality of constructed machine learning models that generates prediction data for a business unit, and the at least one challenger represents at least one other of the plurality of constructed machine learning models that generates prediction data for evaluation.

22. The non-transitory computer-readable medium of claim 1, wherein the operations further comprise:
automatically, and without human intervention, formatting the training data and the validation data for storage in a data repository;
automatically, and without human intervention, storing the scoring data retrieved from the one or more sources of scoring data in the data repository;
automatically, and without human intervention, storing the score data in the data repository;
automatically, and without human intervention, storing the one or more performance metrics computed based on the prediction data and the score data in the data repository;
automatically, and without human intervention, formatting the updated training data and the updated validation data for storage in the data repository; and
automatically, and without human intervention, storing the updated build data in the data repository.
